(19) United States
(12) Patent Application Publication
(10) Pub. No.: US 2008/0244893 A1
(43) Pub. Date: Oct. 9, 2008

(54) STEEL CORE BRASS STAIR ROD

(76) Inventor: D. Hussein Zoroufy, Verona, WI (US)

Correspondence Address: FOLEY & LARDNER LLP, 150 EAST GILMAN STREET, P.O. BOX 1497, MADISON, WI, 53701-1497, US

(21) Appl. No.: 11/696,409

(22) Filed: Apr. 4, 2007

(51) Int. Cl. B23P 17/00; A47G 27/06

(52) U.S. Cl. 29/592; 16/12

(57) ABSTRACT

A steel core brass stair rod includes a steel core with an exterior surface. A brass shell is fused to the exterior surface of the steel core through a heating process such that there is not an air gap between the brass shell and the exterior surface of the steel core.

### FIELD

The subject of the disclosure relates generally to stair rods. More specifically, the disclosure relates to a stair rod which includes a solid brass outer shell fused to a steel core such that there are no air spaces between the solid brass outer shell and the steel core.

### BACKGROUND

A stair rod can be a support member used to secure a carpet, a rug, or other material to a stair (or step). There are currently six types of stair rods in use: solid brass stair rods, brass tube stair rods, solid steel stair rods, steel tube stair rods, aluminum stair rods, and wood stair rods. A solid brass stair rod is desirable because it provides the aesthetically pleasing look of real brass, because it is of sufficient weight, and because it generates an acceptable sound when it is kicked or otherwise touched as an individual goes up and down a set of stairs. However, due to its composition, the solid brass stair rod is prohibitively expensive when compared to the other types of stair rods. As a result, a set of solid brass stair rods is often more expensive than the stair carpet runner which the stair rods are meant to adorn. In addition, the solid brass stair rod is also extremely flexible and prone to bending, especially as the length of the brass stair rod increases. This flexibility can be problematic during installation and can result in a safety hazard when the solid brass stair rod is in use.

As with the solid brass stair rod, the brass tube stair rod is also made of 100% brass. However, because of its hollow center, the brass tube stair rod generally requires about 50% less brass than a solid brass stair rod of the same diameter. As a result, the brass tube stair rod is more affordable than the solid brass stair rod, while still providing the aesthetically pleasing look of real brass. However, the brass tube stair rod lacks an aesthetically desirable weight and produces a cheap ‘tin-like’ sound when it is touched or kicked by passersby. The brass tube stair rod is also extremely flexible and even more likely to bend than the solid brass stair rod. Also, brass tube stair rods with thin walls are susceptible to being dented, twisted, punctured, or otherwise deformed while in use.

The solid steel stair rod provides a high level of strength which is generally not prone to bending or deformity, even in longer lengths. Similar to the solid brass stair rod, the solid steel stair rod also satisfies the aesthetically desirable attributes of weight and sound when in use. In addition, steel is much less expensive than brass. However, the solid steel stair rod has a very poor appearance which is aesthetically unacceptable to most individuals. Further, the solid steel stair rod is susceptible to rusting if left untreated. In an attempt to improve the appearance of the solid steel stair rod and prevent its rusting, the solid steel stair rod can be plated with a brass coating. However, brass plating does not produce the same appearance as solid brass, and as a result, a brass plated stair rod can easily be visually distinguished from a solid brass stair rod by its light appearance, lack of richness, and poor depth of color. As such, a brass plated stair rod is not as aesthetically desirable in appearance as the solid brass stair rod. The brass plating is also susceptible to bubbling, flaking, and/or other inconsistencies. These problems can be caused by imperfections on the steel surface, imperfections within the brass plating material, an improperly implemented plating process, etc. In addition, brass plating is a complicated process which creates a considerable amount of waste water and vapor, both of which are harmful to the environment.

The steel tube stair rod provides a much lower cost than the solid brass stair rod, the brass tube stair rod, or the solid steel stair rod. However, the steel tube is not desirable in appearance, does not have a desirable weight, and does not produce a desirable sound. Further, brass plating the steel tube stair rod does not produce a desirable stair rod for the same reasons described above with reference to the solid steel stair rod.

The aluminum stair rod, which is generally low in price, is the least common type of stair rod. The aluminum stair rod does not have the aesthetically desirable appearance of brass. To remedy its appearance, the aluminum stair rod can be colored (not plated) to a gold-like color using a method called anodizing. While the color produced through anodizing is similar to brass, it is not close enough for most consumers. In addition, the aluminum stair rod is poor in terms of weight, the sound which it produces, and its strength when in use. Overall, the aluminum stair rod is generally deemed the least desirable type of stair rod.

As with the aluminum stair rod, the wood stair rod is another uncommonly used type of stair rod. Wood stair rods are inexpensive and produce an acceptable sound when kicked or otherwise contacted. However, the wood stair rod bends easily and is susceptible to breaking. Also, the appearance of wood is not aesthetically pleasing to most consumers.

Thus, there is a need for a stair rod which is affordable, which produces a desirable (non-tinny) sound when struck, which has the aesthetically desirable appearance of real brass, which has a desirable weight, which is not flexible or otherwise susceptible to deformation, and which is not environmentally harmful.

### SUMMARY

An exemplary steel core brass stair rod includes a steel core with an exterior surface. A brass shell is fused to the exterior surface of the steel core through a heating process such that there is not an air gap between the brass shell and the exterior surface of the steel core.

An exemplary method of making a steel core brass stair rod includes placing a brass billet into a chamber of an extrusion apparatus. The brass billet has an aperture capable of receiving a steel core. The brass billet is heated to a temperature at which the brass billet is pliable. The brass billet and the steel core are co-extruded through a die of the extrusion apparatus such that the brass billet forms a brass shell which is fused to the steel core, wherein there is no air gap between the brass shell and the steel core.

Another exemplary method of making a steel core brass stair rod includes placing a brass tube into a chamber of a drawing apparatus, wherein the brass tube is capable of receiving a steel core. The method also includes heating the brass tube to a temperature at which the brass tube is pliable. The method further includes co-drawing the brass tube and the steel core through a die of the drawing apparatus such that the brass tube forms a brass shell which is fused to the steel core, wherein there is no air gap between the brass shell and the steel core.

Other principal features and advantages will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a flow diagram illustrating operations performed to create a steel core brass stair rod in accordance with an exemplary embodiment.

FIG. 2 is a cross-sectional side view of an extrusion apparatus in accordance with an exemplary embodiment.

FIG. 3 is a front view of the extrusion apparatus of FIG. 2 in accordance with an exemplary embodiment.

FIG. 4 is a cross-sectional side view of a drawing apparatus in accordance with an exemplary embodiment.

FIG. 5 is a partial perspective view of a steel core brass stair rod in accordance with an exemplary embodiment.

### DETAILED DESCRIPTION

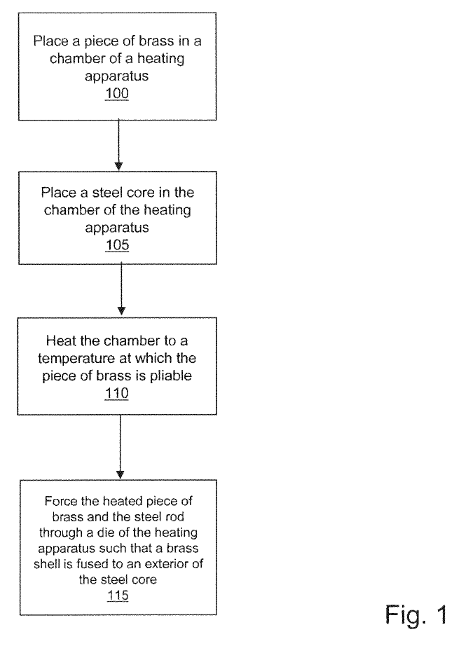

FIG. 1 is a flow diagram illustrating operations performed to create a steel core brass stair rod in accordance with an exemplary embodiment. Additional, fewer, or different operations may be performed in alternative embodiments. In an operation 100, a piece of brass is placed in a chamber of a heating apparatus. In an exemplary embodiment, the piece of brass can be a brass billet. Alternatively, the piece of brass can be a brass tube, a brass ring, or any other brass base. In an operation 105, a steel core is placed in the chamber of the heating apparatus. The steel core can be made of any type of steel known to those of skill in the art. In an exemplary embodiment, the steel core can be solid steel and can have a cylindrical shape. Alternatively, the steel core can be any other shape, including rectangular, triangular, etc. In another alternative embodiment, the steel core can be a steel tube with a hollow center. In an alternative embodiment, steel may not be used, and the core may be made of any other metallic material which has a significantly higher melting point than brass.

In an exemplary embodiment, the piece of brass can include an aperture capable of receiving the steel core. The aperture can be located at a center of the piece of brass, or off-center, depending on the embodiment. In one embodiment, the aperture can be the same shape as the steel core. Alternatively, the aperture can be any other shape capable of receiving the steel core. In another exemplary embodiment, the piece of brass can be the same shape as the chamber into which it is placed.

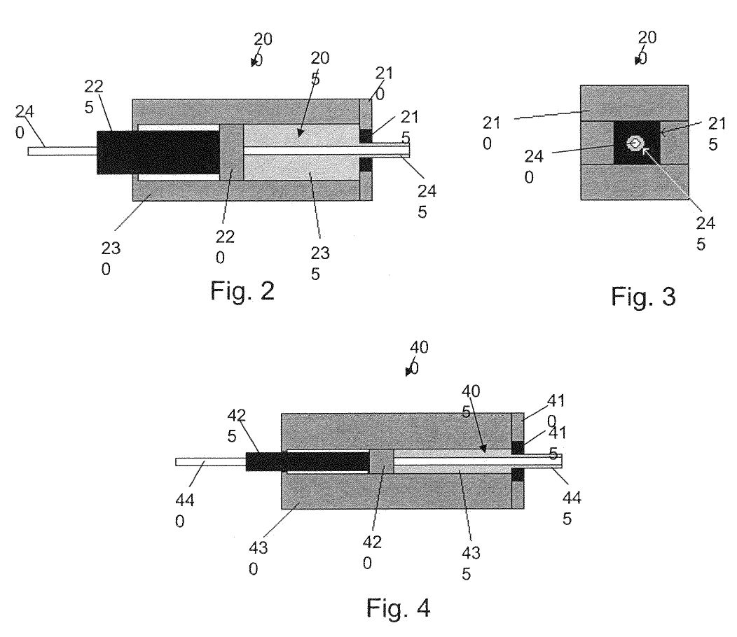

In an exemplary embodiment, the heating apparatus can be an extrusion apparatus. FIG. 2 is a cross-sectional side view of an extrusion apparatus 200 in accordance with an exemplary embodiment. Extrusion apparatus 200 includes a chamber 205, a die holder 210, a die 215, a pressure plate 220, a ram 225, and a casing 230. A brass billet 235 can be placed within chamber 205. A steel core 240 can also be placed within chamber 205 and through an aperture of brass billet 235. In an exemplary embodiment, pressure plate 220 and/or ram 225 can also include apertures capable of receiving steel core 240.

Referring back to FIG. 1, the chamber is heated to a temperature at which the piece of brass is pliable in an operation 110. The chamber can be heated by any method known to those of skill in the art. In an exemplary embodiment, the temperature can be a melting point temperature of brass, which is approximately 1700° Fahrenheit (F). Alternatively, the temperature can be greater than the melting point temperature of brass. In another alternative embodiment, the temperature can be less than the melting point temperature of brass, but still hot enough such that the piece of brass is pliable. In another exemplary embodiment, the temperature can be less than a melting point temperature of steel, which is approximately 2500°-2700° F. As such, there can be no risk of the steel core melting or otherwise deforming during the creation of the steel core brass stair rod.

In an operation 115, the heated piece of brass and the steel rod are forced through a die of the heating apparatus such that a brass shell is fused to an exterior surface of the steel core. In an exemplary embodiment, the steel core can be manually pushed through extrusion apparatus. Alternatively, the steel core may be automatically drawn through the heating apparatus. In another exemplary embodiment, because the piece of brass is pliable, it can conform to the steel core such that there is no air space between the brass shell and the steel core. For example, the exterior surface of the steel core may have ridges, valleys, burrs, and/or other imperfections. An interior of the brass shell can precisely conform to any of these imperfections such that the brass shell and the steel core essentially become a single piece of metal. As such, there is no risk that the steel core can rattle, click, or otherwise move around and make noise within the brass shell. An exterior of the brass shell can be perfectly smooth and visually appealing because the exterior of the brass shell is formed by the die and is not dependent on the flawed exterior surface of the steel core. Further, the brass shell can be any desired thickness. In an exemplary embodiment, different dies and/or methods of manufacturing can be used to produce brass shells of different thicknesses.

Referring back to FIG. 2, chamber 205 can be heated to a temperature such that brass billet 235 is pliable. Once brass billet 235 is pliable, extrusion apparatus 200 can be used to co-extrude brass billet 235 and steel core 240 through die 215. In an exemplary embodiment, pressure plate 220 can make a tight seal with an interior wall of chamber 205 such that brass billet 235 is not able to leak behind pressure plate 220 as pressure plate 220 is pushed along chamber 205. Ram 225 can used to push pressure plate 220 along chamber 205 such that pressure plate 220 forces brass billet 235 and steel core 240 through die 215. Ram 225 can be mounted to pressure plate 220, or detachable therefrom, depending on the embodiment. Pressure can be manually applied to ram 225 by an individual, automatically applied to ram 225 by a computer activated mechanism, hydraulically applied to ram 225, or applied to ram 225 by any other method known to those of skill in the art.

In an exemplary embodiment, steel core 240 and brass billet 235 can pass through die 215 at the same rate. Alternatively, steel core 240 and brass billet 235 can pass through die 215 at differing rates. Die 215 can include a die aperture capable of shaping an exterior surface of a brass shell 245 as brass shell 245 is simultaneously formed and fused to steel core 240. In an exemplary embodiment, the die aperture can be circular. Alternatively, the die aperture can be any other shape. FIG. 3 is a front view of extrusion apparatus 200 of FIG. 2 in accordance with an exemplary embodiment. FIG. 3 illustrates die holder 210, die 215, and co-extruded brass shell 245 fused to steel core 240.

In an exemplary embodiment, brass shell 245 can conform to steel core 240 such that there is no air space between brass shell 245 and steel core 240. The co-extruded brass shell 245 and steel core 240 can be cut to any desired length to form the steel core brass stair rod. The co-extruded brass shell 245 and steel core 240 can be cut by any method known to those of skill in the art, and can be cut prior to or subsequent to cooling, depending on the embodiment. In an exemplary embodiment, the ends of the steel core brass stair rod can be covered by fasteners when the steel core brass stair rod is installed such that there is no visible steel in the installed product. Alternatively, brass can be fused to the ends of the steel core brass stair rod such that there is no visible steel in the finished product.

In an alternative embodiment, the heating apparatus described with reference to FIG. 1 can be a drawing apparatus. The drawing apparatus can be used to form a brass shell which is thinner than brass shell 245 formed by extrusion apparatus 200 described with reference to FIGS. 2 and 3. FIG. 4 is a cross-sectional side view of a drawing apparatus 400 in accordance with an exemplary embodiment. Drawing apparatus 400 includes a chamber 405, a die holder 410, a die 415, a pressure plate 420, a ram 425, and a casing 430. Pressure plate 420 and/or ram 425 can have apertures capable of receiving a steel core 440.

In an exemplary embodiment a brass tube 435 and steel core 440 can be placed in drawing apparatus 400. Brass tube 435 can have a significantly smaller diameter than brass billet 235 described with reference to FIG. 2. Brass tube 435 can also have an aperture capable of receiving steel core 440. Chamber 405 can be heated such that brass tube 435 is made pliable. In an exemplary embodiment, the drawing process can be similar to the extrusion process described with reference to FIGS. 2 and 3. Ram 425 can apply pressure to pressure plate 420 such that brass tube 435 and steel core 440 can be co-drawn through die 415. A brass shell 445 can be fused to steel core 440 such that there is no air space between brass shell 445 and steel core 440. The co-drawn brass shell 445 and steel core 240 can be cut to any desired length to form the steel core brass stair rod. In an alternative embodiment, the steel core brass stair rod can be made by any other method capable of fusing a brass shell to a steel core in an airtight fashion.

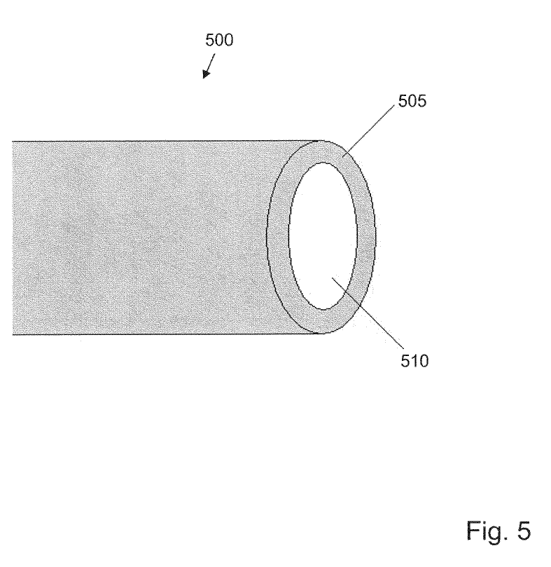

FIG. 5 is a partial perspective view of a steel core brass stair rod 500 in accordance with an exemplary embodiment. Steel core brass stair rod 500 includes a brass shell 505 fused to a steel core 510. In an exemplary embodiment, steel core brass stair rod 500 can be made using an extrusion process, a drawing process, or any other process capable of fusing brass shell 505 to steel core 510 such that there are no air spaces between brass shell 505 and steel core 510.

The steel core brass stair rod described herein overcomes the limitations of the above-described prior art stair rods. The steel core brass stair rod can be inexpensive because it can be made by using a small amount of brass. The steel core brass stair rod can have a desirable weight because it can be made solid throughout its diameter (or width). Because the brass shell is fused to the brass core in an airtight manner, the steel core brass stair rod does not produce undesirable ‘tinny’ or other sounds as individuals go up and down a set of stairs. In addition, because of the steel core, there is no risk that the steel core brass stair rod will bend or otherwise deform during use or installation. The steel core brass stair rod also has an aesthetically desirable appearance because the solid brass shell is the only visible metal when the steel core brass stair rod is installed. Unlike brass plating, the brass shell is genuine brass and does not suffer from a light appearance or other discoloration. In addition, the co-extrusion and co-drawing methods described herein are significantly more friendly to the environment than the brass plating method used in the prior art.

It is also important to understand that the steel core brass stair rod described herein is significantly different from a brass tube with a steel core insert. A brass tube with an non-fused steel core insert would suffer from the same limitations as described with reference to the prior art. As known to those of skill in the art, brass tubes are manufactured with a specified tolerance. For example, a brass tube with a wall thickness of 0.031 inches might require a tolerance of ±0.0005 inches along the entire length of the brass tube. This alone allows a variation of up to 0.001 inches in the wall thickness along the brass tube. If a steel core is inserted into such a brass tube, the variation can result in undesirable air spaces between the steel core and the brass tube. The undesirable air spaces can allow the steel core to move within the brass tube such that undesirable noises are generated. In addition, the interior surface of a brass tube is left rough, and there is no commercially available process of polishing it smooth. This rough interior surface would also contribute to undesirable air spaces between the brass tube and a steel core insert.

Use of a non-fused steel core insert would further be limited because an exterior surface of a steel core (or rod) is generally extremely rough after it is manufactured. Leaving this rough exterior surface would result in many air spaces between the steel core and the brass tube. Polishing the exterior surface of the steel core to make it smooth would also cause air spaces because the act of polishing removes steel from the steel core, resulting in a smaller diameter steel core which is free to move about within the brass tube. Further, current manufacturing methods of both brass tubes and steel cores (rods) have tolerances with respect to curvature. A brass tube and/or steel core which is curved can cause significant air spaces between the brass tube and steel core. Thus, it can be seen that simply inserting a non-fused steel core into a brass tube would not solve the above-described limitations of traditional stair rods.

One or more flow diagrams have been used to describe exemplary embodiments. The use of flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A steel core brass stair rod comprising:
a steel core comprising an exterior surface; and
a brass shell fused to the exterior surface through a heating process such that there is not an air gap between the brass shell and the exterior surface of the steel core.

2. The steel core brass stair rod of claim 1, wherein the steel core comprises a solid steel core.

3. The steel core brass stair rod of claim 1, wherein the steel core is at least partially hollow.

4. The steel core brass stair rod of claim 1, wherein the heating process comprises an extrusion process during which a brass billet is heated to a temperature at which the brass billet is pliable and co-extruded with the steel core through a die.

5. The steel core brass stair rod of claim 4, wherein the temperature is less than a melting point temperature of the steel core.

6. The steel core brass stair rod of claim 4, wherein the temperature is greater than or equal to a melting point temperature of the brass billet.

7. The steel core brass stair rod of claim 4, wherein the brass billet comprises an aperture capable of receiving the steel core.

8. The steel core brass stair rod of claim 7, wherein the aperture is located at a center of the brass billet.

9. The steel core brass stair rod of claim 1, wherein the heating process comprises a drawing process during which a brass tube is heated to a temperature at which the brass tube is pliable and co-drawn with the steel core through a die.

10. A method of making a steel core brass stair rod comprising:
placing a brass billet into a chamber of an extrusion apparatus wherein the brass billet comprises an aperture capable of receiving a steel core;
heating the brass billet to a temperature at which the brass billet is pliable; and
co-extruding the brass billet and the steel core through a die of the extrusion apparatus such that the brass billet forms a brass shell which is fused to the steel core, wherein there is no air gap between the brass shell and the steel core.

11. The method of claim 10, wherein the temperature is greater than or equal to a melting point temperature of the brass billet.

12. The method of claim 10, wherein the temperature is less than a melting point temperature of the steel core.

13. The method of claim 10, wherein co-extruding the brass billet and the steel core comprises applying a force to a ram of the extrusion apparatus such that the ram causes a pressure plate of the extrusion apparatus to force the brass billet and the steel core through the die.

14. The method of claim 13, wherein the pressure plate comprises an aperture capable of receiving the steel core.

15. The method of claim 13, wherein the ram comprises an aperture capable of receiving the steel core.

16. The method of claim 10, wherein the die comprises a circular aperture of a specified diameter.

17. A method of making a steel core brass stair rod comprising:
placing a brass tube into a chamber of a drawing apparatus, wherein the brass tube is capable of receiving a steel core;
heating the brass tube to a temperature at which the brass tube is pliable; and
co-drawing the brass tube and the steel core through a die of the drawing apparatus such that the brass tube forms a brass shell which is fused to the steel core, wherein there is no air gap between the brass shell and the steel core.

18. The method of claim 17, wherein the drawing apparatus further comprises:
a pressure plate which forms a seal with an interior of the chamber; and
a ram capable of applying a force to the pressure plate such that the pressure plate forces the brass tube and the steel core through the die.

19. The method of claim 18, wherein the ram and the pressure plate comprise apertures capable of receiving the steel core.

20. The method of claim 17, wherein the brass tube and the steel core are drawn through the die at an identical rate.
